(19) United States
(12) Patent Application Publication
(10) Pub. No.: US 2026/0119010 A1
(43) Pub. Date: Apr. 30, 2026

(54) CONTENT DISPLAY METHOD, NON-TRANSITORY COMPUTER-READABLE MEDIUM AND ELECTRONIC DEVICE

(71) Applicant: Beijing Youzhuju Network Technology Co., Ltd., Beijing (CN)

(72) Inventors: Shaoyuan ZHU, Beijing (CN); Xinle LIU, Beijing (CN); Di PAN, Beijing (CN); Yixin HOU, Beijing (CN); Xin DING, Beijing (CN); Chao XUE, Beijing (CN); Xiaomin SONG, Beijing (CN); Xin WU, Beijing (CN)

(21) Appl. No.: 19/374,923

(22) Filed: Oct. 30, 2025

(30) Foreign Application Priority Data
Oct. 31, 2024 (CN) 202411548631.7

(51) Int. Cl. G06F 3/0483; G06F 3/0482; G06F 3/0484; G06Q 30/0251

(52) U.S. Cl. CPC G06F 3/0483; G06F 3/0482; G06F 3/0484; G06Q 30/0251

(57) ABSTRACT

The present disclosure provides a content display method, a non-transitory computer-readable medium and an electronic device. The content display method includes: displaying an identification of an intelligent object in a page of a content delivery platform, the intelligent object is at least used to provide a data analysis result of historical delivery data and/or a delivery recommendation for a content delivery policy; and displaying, in response to interaction operation information in the page meeting a preset condition, the data analysis result and/or the delivery recommendation through the intelligent object.

### CROSS-REFERENCE TO RELATED APPLICATION

The present disclosure claims the priority and benefits of Chinese patent application No. 202411548631.7 entitled “CONTENT DISPLAY METHOD, APPARATUS, READABLE MEDIUM, ELECTRONIC DEVICE AND PROGRAM PRODUCT” and filed in Chinese Patent Office on Oct. 31, 2024, the entirety of which is incorporated into the present disclosure by reference.

### TECHNICAL FIELD

The present disclosure relates to a content display method, a non-transitory computer-readable medium and an electronic device.

### BACKGROUND

With the development of computer technologies, a business platform can provide more and more abundant functions for users. For example, in a content delivery platform, after delivering content through the content delivery platform, a data viewing function can be used to display content related to the delivered content in a page.

However, in the related art, the content related to the delivered content displayed in the page is generally basic data of the delivered content, and there is a problem that the displayed content is monotonous.

### SUMMARY

The Summary is provided to introduce concepts in a simplified form, and these concepts will be described in detail in the Detailed Description below. The Summary is not intended to identify key features or essential features of the claimed technical solutions, nor is it intended to be used to limit the scope of the claimed technical solutions.

In an aspect, the present disclosure provides a content display method, the content display method comprises:
displaying an identification of an intelligent object in a page of a content delivery platform, wherein the intelligent object is at least used to provide a data analysis result of historical delivery data and/or a delivery recommendation for a content delivery policy; and
displaying, in response to interaction operation information in the page meeting a preset condition, the data analysis result and/or the delivery recommendation through the intelligent object.

In an aspect, the present disclosure provides a content display apparatus, the content display apparatus comprises:
a first display module, used to display an identification of an intelligent object in a page of a content delivery platform, wherein the intelligent object is at least used to provide a data analysis result of historical delivery data and/or a delivery recommendation for a content delivery policy; and
a second display module, used to display, in response to interaction operation information in the page meeting a preset condition, the data analysis result and/or the delivery recommendation through the intelligent object.

In an aspect, the present disclosure provides a computer-readable medium having computer programs stored thereon that when executed by a processing apparatus, implement the steps of the method provided by the embodiments of the present disclosure.

In an aspect, the present disclosure provides an electronic device, comprising:
a storage apparatus having computer programs stored thereon; and
a processing apparatus, used to execute the computer programs in the storage apparatus to implement the steps of the method provided by the embodiments of the present disclosure.

In an aspect, the present disclosure provides a computer program product, comprising computer programs that when executed by a processor, implement the steps of the method provided by the embodiments of the present disclosure.

### BRIEF DESCRIPTION OF DRAWINGS

The above and other features, advantages and aspects of various embodiments of the present disclosure will become more apparent when taken in conjunction with the drawings and with reference to the following specific implementations. Throughout the drawings, the same or similar reference numerals represent the same or similar elements. It should be understood that the drawings are schematic and that parts and elements are not necessarily drawn to scale. In the drawings:

FIG. 1 is a flowchart of a content display method according to an exemplary embodiment of the present disclosure;

FIG. 2 is a schematic diagram of display positions of a data analysis result and/or a delivery recommendation according to an exemplary embodiment of the present disclosure;

FIG. 3 is a schematic diagram of displaying a data analysis result and/or a delivery recommendation through an intelligent object according to an exemplary embodiment of the present disclosure;

FIG. 4 is a schematic diagram of displaying a delivery recommendation through an intelligent object according to an exemplary embodiment of the present disclosure;

FIG. 5 is a schematic diagram of displaying detailed information of a delivery recommendation and a third control in a first intelligent object page according to an exemplary embodiment of the present disclosure;

FIG. 6 is a schematic diagram of displaying detailed information of a delivery recommendation and a fifth control in a second intelligent object page according to an exemplary embodiment of the present disclosure;

FIG. 7 is a schematic diagram of displaying prompt information according to an exemplary embodiment of the present disclosure;

FIG. 8 is a schematic diagram of displaying prompt information according to an exemplary embodiment of the present disclosure;

FIG. 9 is a schematic diagram of displaying prompt information according to an exemplary embodiment of the present disclosure;

FIG. 10 is a schematic diagram of displaying a query function in a first intelligent object page according to an exemplary embodiment of the present disclosure;

FIG. 11 is a structural block diagram of a page display apparatus according to an exemplary embodiment of the present disclosure; and

FIG. 12 is a structural schematic diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms, and should not be construed as being limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that various steps described in method implementations of the present disclosure may be performed in a different order and/or in parallel. In addition, the method implementations may include additional steps and/or omit performing the illustrated steps. The scope of the present disclosure is not limited in this respect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between the plurality of apparatuses in the implementations of the present disclosure are only used for illustrative purposes, and are not intended to limit the scope of these messages or information.

It can be understood that before using the technical solutions disclosed in respective embodiments of the present disclosure, users should be informed of the types, usage scopes, usage scenarios, etc. of the personal information involved in the present disclosure in an appropriate manner in accordance with relevant laws and regulations, and authorization from the users should be obtained.

For example, in response to receiving an active request from a user, prompt information is sent to the user to explicitly prompt the user that an operation requested by the user will require acquisition and use of the user's personal information. Therefore, the user can select whether to provide personal information to a software or hardware such as an electronic device, an application, a server or a storage medium that performs the operations of the technical solutions of the present disclosure on his/her own according to the prompt information.

As an optional but non-limiting implementation, a manner of sending the prompt information to the user in response to receiving the active request from the user may be, for example, a pop-up window, and the prompt information may be presented in the pop-up window in a form of text. In addition, the pop-up window may also carry a selection control for the user to select “Agree” or “Disagree” to provide personal information to the electronic device.

It can be understood that the above process of notification and acquisition of the user's authorization is only schematic, and does not constitute a limitation to implementations of the present disclosure. Other manners that satisfy relevant laws and regulations may also be applied to the implementations of the present disclosure.

Meanwhile, it can be understood that the data involved in the technical solutions (including but not limited to the data itself, and the acquisition or usage of the data) should comply with requirements of corresponding laws, regulations and related provisions.

As described in the Background, in the related art, a content delivery platform can be used for content delivery. However, in the related art, after content delivery is performed based on the content delivery platform, generally a user can only view some basic data of the delivered content, for example, basic data such as consumption data and/or conversion cost. However, since the basic data is relatively monotonous, it is often impossible to intuitively reflect the actual effect of content delivery, and it is also difficult to determine whether the delivery policy needs to be optimized. Therefore, the user needs to perform in-depth data analysis based on the basic data before obtaining the content delivery effect and/or determining whether the content delivery policy needs to be optimized. That is to say, in the related art, the content delivery platform lacks effective delivery data diagnosis and delivery policy guidance, and there are problems such as inaccurate data analysis and low analysis efficiency.

In addition, since the basic data is generally distributed in different pages of the content delivery platform, when performing data analysis based on the basic data, it is necessary to collect the basic data across pages, the operations of which are cumbersome. For example, it is necessary to first collect data indicators and/or data dimensions of the basic data in different pages of the content delivery platform, and then fill the collected data indicators and/or data dimensions into a customized report, thereby obtaining a data analysis result, etc.

In view of this, the present disclosure provides a content display method, an apparatus, a readable medium, an electronic device and a program product to solve the above technical problems.

The embodiments of the present disclosure will be further explained below with reference to the drawings.

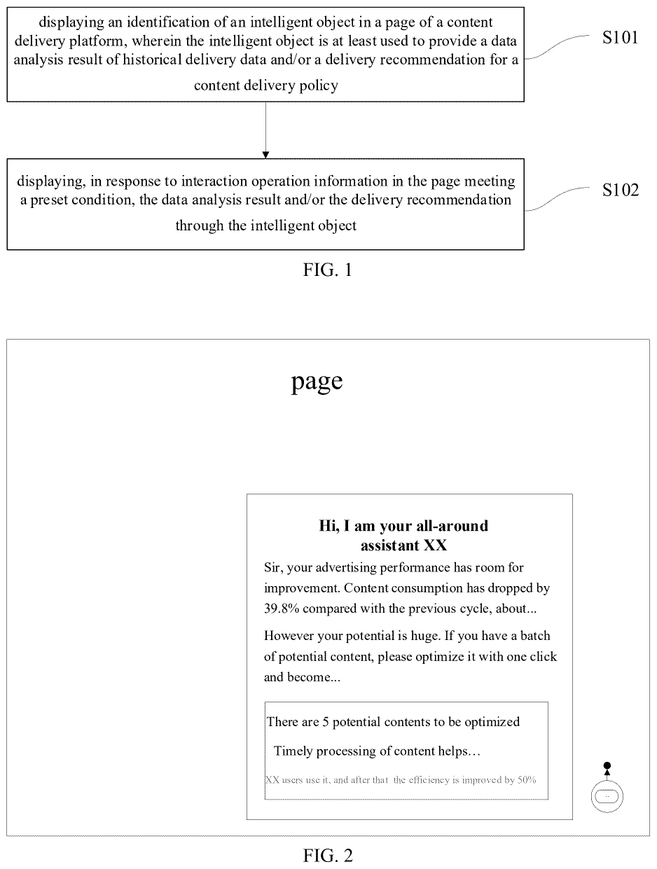

FIG. 1 is a flowchart of a content display method according to an exemplary embodiment of the present disclosure, and referring to FIG. 1, the content display method may include the following steps.

S101: displaying an identification of an intelligent object in a page of a content delivery platform, and the intelligent object is at least used to provide a data analysis result of historical delivery data and/or a delivery recommendation for a content delivery policy.

In this embodiment, the page may be a page for users to browse, manage and deliver content in the content delivery platform. For example, it may be a home page that users to first see after logging in to the content delivery platform, or may be an operation page of different functional modules in the content delivery platform.

In this embodiment, the intelligent object may be an agent integrating at least one machine learning model such as a data analysis model. The agent can receive historical delivery data in formats such as texts, voices or images input from the outside, or can automatically collect historical delivery data of different users in the content delivery platform, and analyze and process the received or automatically collected historical delivery data by using the integrated data analysis model, to generate the data analysis result of the historical delivery data and/or the delivery recommendation for the content delivery policy. In addition, since the machine learning model generally has capabilities such as semantic polishing and/or text optimization, when the data analysis result of the historical delivery data and/or the delivery recommendation is generated through the intelligent object, the expression of the data analysis result and/or the delivery recommendation can be made clearer, more accurate and easier to be understood by the users, thereby helping the users quickly grasp the key points of the data analysis result and/or the delivery recommendation.

In this embodiment, the historical delivery data may be used to indicate delivery data of all content delivered in the content delivery platform within a preset time period, or may be used to indicate delivery data of all delivered content delivered in a current page within a preset time period, and may also be used for other purposes, which is not limited in the embodiments of the present disclosure. Exemplarily, in a non-content delivery page, the historical delivery data may refer to the delivery data of all content delivered in the content delivery platform, and in a content delivery page, the historical delivery data may refer to the delivery data of all delivered content delivered in the current content delivery page. The delivery data may include a delivery cost, a delivery time, delivered content, consumption data and/or a delivery frequency, and so on.

S102: displaying, in response to interaction operation information in the page meeting a preset condition, the data analysis result and/or the delivery recommendation through the intelligent object.

In this embodiment, the preset condition may be determined according to actual conditions, which is not limited in the embodiments of the present disclosure.

Exemplarily, in the case where the user authorization is obtained, the interaction operation of the user in the page may be detected, and when it is detected that the user triggers the identification of the intelligent object in the page, the data analysis result and/or the delivery recommendation are displayed through the intelligent object. Alternatively, in the case where the user authorization is obtained, the interaction operation of the user in the page may be detected, and when it is detected that the user triggers the identification of the intelligent object in the page, the intelligent object page is displayed, and when it is detected that the user inputs a target instruction for displaying the data analysis result and/or the delivery recommendation in the intelligent object page, the data analysis result and/or the delivery recommendation are displayed through the intelligent object. Alternatively, a first target interaction action for triggering the displaying of the data analysis result and/or the delivery recommendation through the intelligent object may be preset, and thus, in the case where the user authorization is obtained, the interaction operation of the user in the page may be detected, and when it is detected that the user performs the first target interaction action in the page, the data analysis result and/or the delivery recommendation are displayed through the intelligent object. The intelligent object page may be a page integrating the intelligent objects, and through the intelligent object page, users can interact with the integrated intelligent objects, for example, have a conversation with the intelligent objects.

In a possible implementation, in order to quickly display the data analysis result and/or the delivery recommendation, and avoid the data analysis result and/or the delivery recommendation distracting the user's attention when the user is performing the second target interaction action in the displaying process, the displaying, in response to the interaction operation information in the page meeting the preset condition, the data analysis result and/or the delivery recommendation through the intelligent object may include: in the case where the user authorization is obtained, if it is detected that the interaction operations in the page does not include a second target interaction action, displaying the data analysis result and/or the delivery recommendation through the intelligent object. The second target interaction action may be set according to actual conditions, which is not limited in the embodiments of the present disclosure. Exemplarily, the second target interaction action may be an interaction action that the user needs to perform with concentration, such as a content edit operation and/or a recharge operation. That is to say, in a possible implementation, the displaying, in response to the interaction operations in the page meeting the preset condition, the data analysis result and/or the delivery recommendation through the intelligent object may include:
in response to the interaction operations in the page not including the content edit operation, displaying the data analysis result and/or the delivery recommendation through the intelligent object; and/or, in response to the interaction operations in the page not including the recharge operation, displaying the data analysis result and/or the delivery recommendation through the intelligent object.

In this embodiment, the delivery recommendation displayed by the intelligent object may be a part of the delivery recommendation for the historical delivery data, or may be the whole delivery recommendation for the historical delivery data. When the delivery recommendation displayed by the intelligent object is a part of the delivery recommendation for the historical delivery data, the delivery recommendation displayed by the intelligent object may be the delivery recommendation with the best delivery effect improvement, or may be any one or more delivery recommendations, and may also be other delivery recommendations, which is not limited in the embodiments of the present disclosure.

In this embodiment, the display position of preview information of the data analysis result and/or the delivery recommendation may be set according to actual conditions, which is not limited in the embodiments of the present disclosure. Exemplarily, the data analysis result and/or the delivery recommendation may be displayed in a form of a card, a bubble, or the like at a preset position around the identification of the intelligent object, as shown in FIG. 2.

According to the above technical solutions, in response to the interaction operation information in the page meeting the preset conditions, the data analysis result and/or the delivery recommendation can be automatically generated through the intelligent object, and the data analysis result and/or the delivery recommendation can automatically reach the user through the intelligent object. Therefore, the data analysis result and/or the delivery recommendation can be automatically generated, the difficulty of generating the data analysis result and/or the delivery recommendation can be reduced, and the efficiency of generating the data analysis result and/or the delivery recommendation can be improved. In addition, since the data analysis result and/or the delivery recommendation can proactively reach the users through a new interaction form of the intelligent object, not only the display content of the page is enriched, but also the users can view the data analysis result and/or the delivery recommendation in time when the data analysis result and/or the delivery recommendation are displayed, thereby improving the response rate of the users to the data analysis result and/or the delivery recommendation.

To facilitate understanding of the content display method provided by the present disclosure, possible implementations in the present disclosure will be described below.

In a possible implementation, the displaying the data analysis result and/or the delivery recommendation through the intelligent object may include:
displaying preview information of the data analysis result and/or the delivery recommendation and a first control, where the first control is used to trigger the displaying of detailed information of the data analysis result and/or the delivery recommendation; and in response to a trigger operation on the first control, displaying a first intelligent object page associated with the intelligent object, and displaying the detailed information of the data analysis result and/or the delivery recommendation through the first intelligent object page.

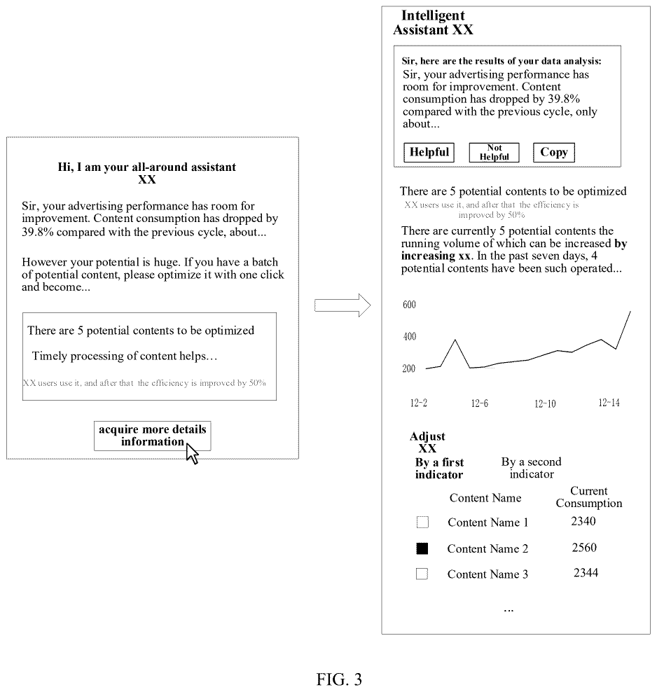

Exemplarily, as shown in FIG. 3, the preview information of the data analysis result, the preview information of the delivery recommendation and the first control “Get more detailed information” may be displayed in the page in the form of a card. In response to an operation triggering the first control “Get more detailed information” such as sliding or clicking, the first intelligent object page associated with the intelligent object is displayed, and the detailed information of the data analysis result and the delivery recommendation are displayed in the first intelligent object page.

In a possible implementation, in order to make the displayed delivery recommendation more directional and more effectively improve the actual effect of content delivery, when the delivery recommendation for the historical delivery data is generated through the intelligent object, candidate delivery recommendations with better content delivery effect may be selected from the generated delivery recommendations. For example, a delivery recommendation with a delivery effect improvement value greater than a preset delivery effect improvement threshold may be selected, and then the preview information of the candidate delivery recommendation is displayed in the page.

Through the above manner, the preview information of the data analysis result and/or the delivery recommendation can be displayed first. On one hand, the user can quickly grasp the core content of the data analysis result and the delivery recommendation, save the time for the user to search for key information in a large amount of data, and improve the content reading efficiency. On the other hand, it can be avoided to display excessive information at one time, and reduce the reading interest of the user. In addition, by displaying the first control used to trigger the displaying of the detailed information of the data analysis result and/or the delivery recommendation, the user can autonomously select whether to view the detailed information of the data analysis result and/or the delivery recommendation, thereby enhancing the user experience.

In a possible implementation, the displaying the preview information of the delivery recommendation may include:
displaying a first number of delivery recommendations in a first preset display region; and
correspondingly, the displaying the detailed information of the delivery recommendation through the first intelligent object page may include:
displaying a second number of delivery recommendations in the first intelligent object page, where the second number of delivery recommendations include the first number of delivery recommendations, and second controls are displayed association with each of the second number of delivery recommendations, and the second controls are at least used to trigger the displaying of detailed information of the associated delivery recommendation; and in response to a trigger operation on any target control in the second controls, displaying detailed information of a target delivery recommendation associated with the target control.

In this embodiment, the first preset display region, the first number and the second number may be determined according to actual conditions, which is not limited in the embodiments of the present disclosure.

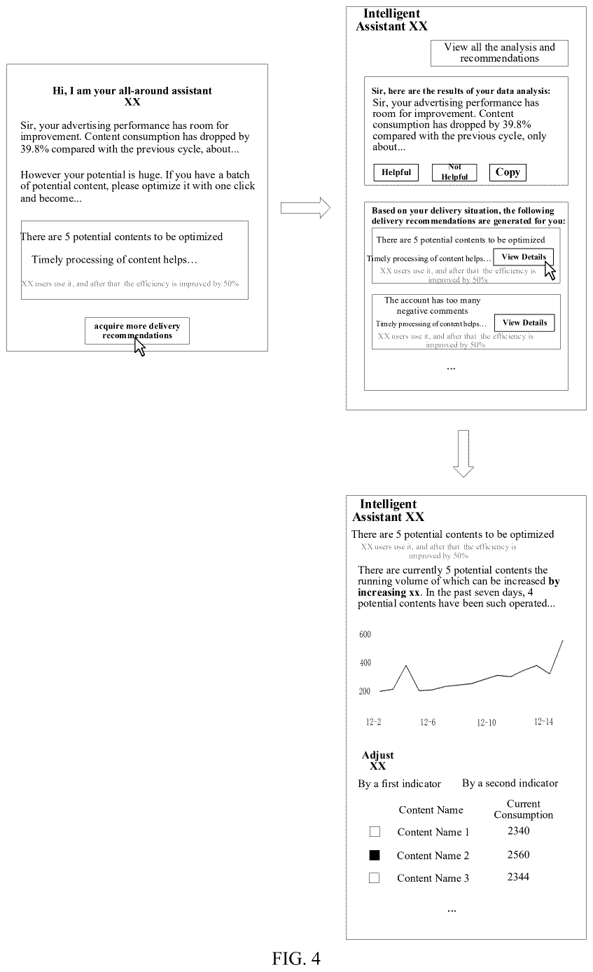

Exemplarily, as shown in FIG. 4, one delivery recommendation with the best delivery effect improvement may be displayed in a middle display region of a bubble or a card, and an acquisition control “Get more delivery recommendations” for acquiring more delivery recommendations may be displayed in a display region below the delivery recommendation. In response to a trigger operation such as clicking or sliding on the acquisition control “Get more delivery recommendations”, the first intelligent object page may be displayed, and the data analysis result and all the delivery recommendations or the second number of delivery recommendations, for example, three delivery recommendations, may be displayed in the first intelligent object page. The second control “View details” for viewing detailed information of the delivery recommendation is displayed in a display region on the right side of each delivery recommendation, and the detailed information of the first delivery recommendation is displayed in the first intelligent object page by clicking on the second control “View details” associated with the first delivery recommendation.

Through the above manner, the first number of delivery recommendations can be displayed in the first preset display region, the second number of delivery recommendations can be displayed in the first intelligent object page, and the second number of delivery recommendations include the first number of delivery recommendations, thereby further avoiding displaying excessive information at one time and reducing the reading interest of the user. In addition, by displaying the second control for triggering the detailed information of each delivery recommendation which is displayed in association with the delivery recommendation, the user can autonomously select whether to view the detailed information of the delivery recommendation or the detailed information of which delivery recommendation to view, thereby further enhancing the user experience.

In a possible implementation, the displaying, in response to the trigger operation on any target control in the second controls, the detailed information of the target delivery recommendation associated with the target control may include:
in response to the trigger operation on any target control in the second controls, displaying the detailed information of the target delivery recommendation associated with the target control in the first intelligent object page; and
correspondingly, the content display method may further include:
displaying a third control for the target delivery recommendation in the first intelligent object page, where the third control is used for the user to modify a content delivery policy based on the target delivery recommendation.

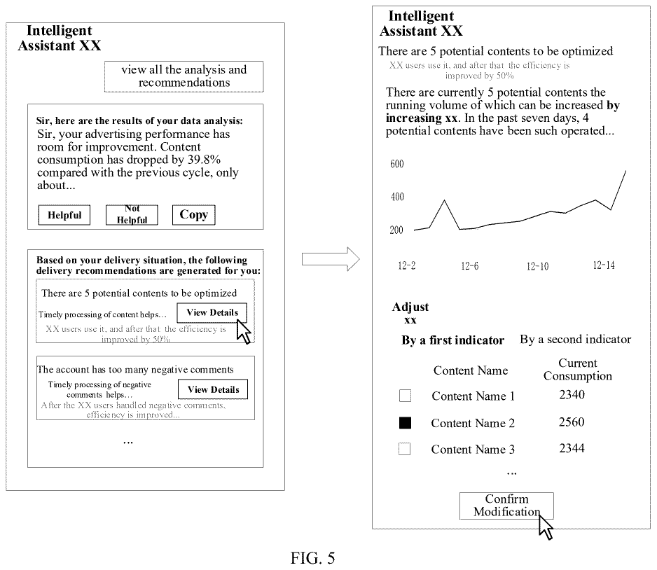

Exemplarily, as shown in FIG. 5, in response to triggering the second control “View details” associated with the first delivery recommendation through an operation such as clicking, the detailed information of the first delivery recommendation and the third control “Confirm modification” are displayed in the first intelligent object page. After the content delivery data under the first indicator and/or the content delivery data under the second indicator are modified based on the target delivery recommendation, for example, after the consumption corresponding to the content name 2 is changed to 2734, the modification of the content delivery policies is completed by clicking on the third control “Confirm modification”.

In a possible implementation, the third control may also prompt the number of modified content delivery policies, so that the user can intuitively and quickly know the number of modified content delivery policies. Exemplarily, if the user modifies three content delivery policies, the third control may also display “Confirm to modify content delivery policies for 3 contents”, or may display “Confirm to modify XX indicators for 3 contents”.

Through the above manner, the detailed information of the data analysis result and/or the delivery recommendation can be displayed in the intelligent object page, and the third control for the user to modify the content delivery policies can be displayed in the intelligent object page, so that the viewing of the data analysis result and/or the delivery recommendation and the modification of the content delivery policies can be realized in the intelligent object page. That is to say, the viewing of the data analysis result and/or the delivery recommendation and the modification of the content delivery policies can be realized without switching the page of the content delivery platform, or the data analysis interpretation, the displaying and adoption of the delivery recommendation, etc. can be completed in the intelligent object page in a closed loop, thereby enhancing the operation coherence of the user, and improving the operation efficiency of the user and the user experience.

In a possible implementation, the content display method may further include:
displaying a fourth control for the user to perform an adoption operation on the delivery recommendation in a second preset region; and in response to a trigger operation on the fourth control, displaying a second intelligent object page associated with the intelligent object, and displaying detailed information of the delivery recommendation and a fifth control in the second intelligent object page, where the fifth control is used for the user to modify a content delivery policy based on the delivery recommendation.

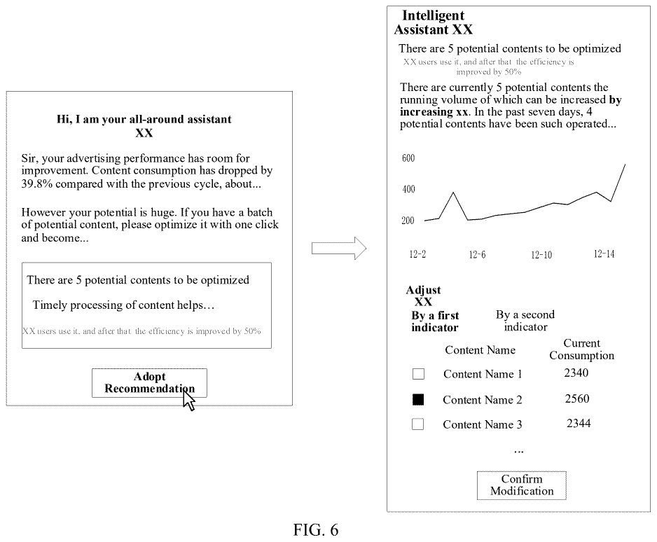

Exemplarily, as shown in FIG. 6, the fourth control “Adopt recommendation” may be displayed in a bottom display region of a bubble or a card. In response to triggering the fourth control “Adopt recommendation” through an operation such as clicking, the second intelligent object page is displayed, and the detailed information of the delivery recommendation and the fifth control “Confirm modification” are displayed in the second intelligent object page. After the content delivery data is modified based on the target delivery recommendation, the modification of the content delivery policies is completed by clicking on the third control “Confirm modification”.

In a possible implementation, after the user adopts the delivery recommendation, in order for the user to know the latest delivery effect of the delivered content in time, the delivery effect of the delivered content may be tracked in real time or periodically, and the latest delivery effect is displayed to the user through the intelligent object page.

Through the above manner, the fourth control for the user to perform the adoption operation on the delivery recommendation can be displayed in the preset region, and thus the delivery recommendation can be quickly adopted by triggering the fourth control, thereby reducing the time cost in the decision-making process and improving the adoption efficiency of the delivery recommendation. In addition, after the fourth control is triggered, the detailed information of the delivery recommendation and the fifth control for the user to modify the content delivery policy can be displayed in the intelligent object page, so that the user can flexibly modify the content delivery policy according to the actual situation, thereby improving the adaptability of the content delivery policy.

In a possible implementation, the content display method may further include:
displaying first prompt information associated with the first control in a third preset region, where the first prompt information is used to prompt virtual resource information associated with the first control; or, in response to the third control being displayed in the first intelligent object page, displaying second prompt information associated with the third control in the first intelligent object page, where the third control is used for the user to modify a content delivery policy based on the target delivery recommendation, and the second prompt information is used to prompt virtual resource information associated with the third control.

In this embodiment, the virtual resource information may be used to indicate the amount of virtual resources that the user can acquire after triggering the first control and/or the third control, or may be used to indicate the conditions for the user to acquire the virtual resources. The virtual resources may be various virtual items, such as virtual gold coins, virtual red envelopes or virtual credits, which is not limited in the embodiments of the present disclosure.

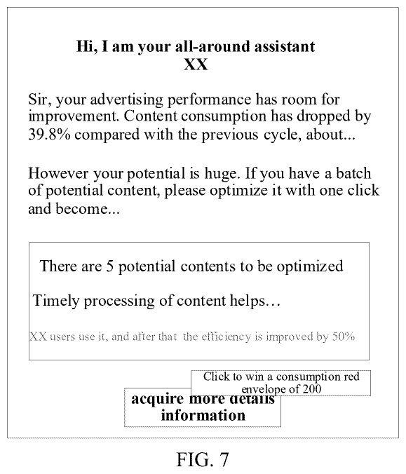

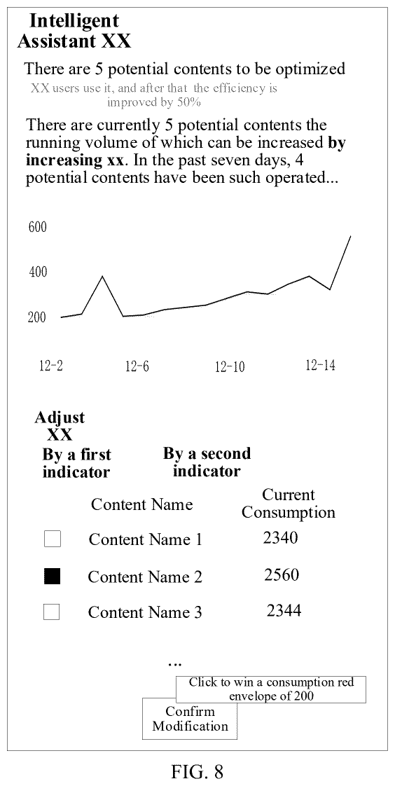

In this embodiment, the display position and/or prompt content of the first prompt information and the second prompt information may be set according to actual conditions, which is not limited in the embodiments of the present disclosure. Exemplarily, in order to allow the user to intuitively and quickly notice the first prompt information, the first prompt information may be displayed at a position around the first control, for example, the first prompt information may be displayed on the top of the first control, as shown in FIG. 7. Similarly, the second prompt information may be displayed at a position around the third control, for example, the second prompt information may be displayed on the top of the second control, as shown in FIG. 8.

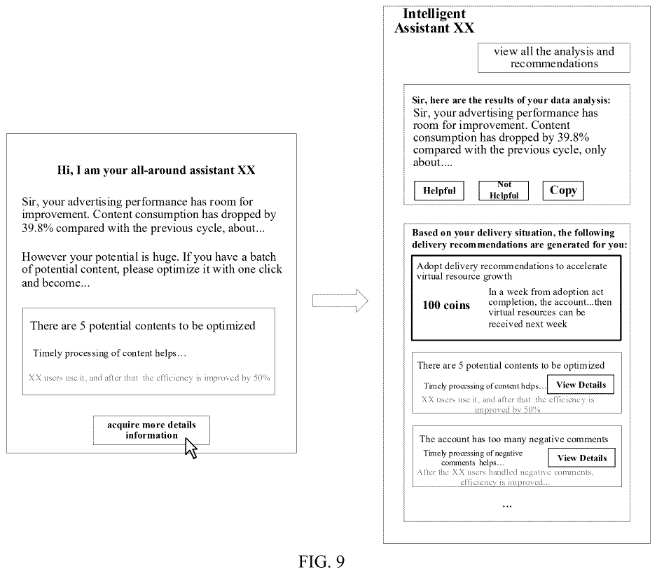

In a possible implementation, in order to further allow the user to intuitively and quickly notice the first prompt information and enrich the display content in the first intelligent display page, when the preview information of the second number of delivery recommendations are displayed in the first intelligent display page, the first prompt information may be highlighted on the top of the preview information of the second number of delivery recommendations, as shown in FIG. 9.

Through the above manner, the virtual resource information can be displayed in the preset region and/or the intelligent object page, so that the virtual resource information can be used to further attract the attention of the user, so that the user can quickly notice the data analysis result and/or the delivery recommendation, and the rate of the user to respond to the data analysis result and/or the delivery recommendation can be further improved.

In a possible implementation, the first intelligent object page is also used to provide a query function for the historical delivery data, and correspondingly, the content display method may further include:
in response to description information for querying the historical delivery data being input in the first intelligent object page, displaying target delivery data obtained by the intelligent object based on the description information in the first intelligent object page.

In this embodiment, the target delivery data may be determined according to actual conditions, which is not limited in the embodiments of the present disclosure. Exemplarily, when the description information for querying the historical delivery data is “query historical delivery data in a target dimension”, the target delivery data may be “historical delivery data in a target dimension”. When the description information for querying the historical delivery data is “query historical delivery data of a first delivery type”, the target delivery data may be “historical delivery data of a first delivery type”.

In this embodiment, when displaying the target delivery data obtained by the intelligent object based on the description information in the first intelligent object page, the queried target delivery data may be directly displayed in a data format, or the queried target delivery data may be displayed in a form of a data diagram or a data table, and may also be displayed in other forms, which is not limited in the embodiments of the present disclosure.

In this embodiment, the description information for querying the historical delivery data input in the first intelligent object page may be input by speech, or may be input in a manner of inputting a natural language text in a text input box, or may be input when the preset description information text is displayed in the first intelligent object page, and the description information text is triggered by an operation such as clicking. Certainly, other input manners may also be adopted, which is not limited in the embodiments of the present disclosure.

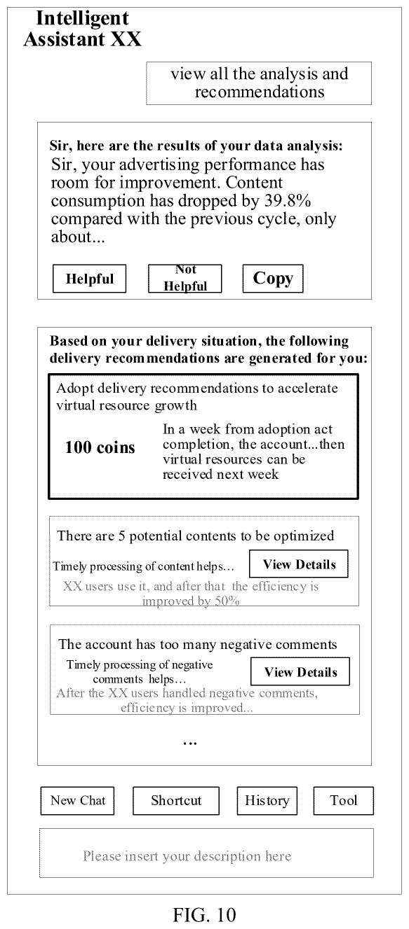

Exemplarily, as shown in FIG. 10, a text input box may be displayed at the bottom of the first intelligent object page, and when the user inputs the description information for querying the historical delivery data in the text input box, the target delivery data obtained by the intelligent object based on the description information is displayed in the first intelligent object page.

It should be understood that in the content delivery platform, the delivery data of the delivered content may generally be distributed in different pages, and thus when querying the delivery data of the delivered content, it is generally necessary to perform the query across pages. Therefore, in the query process, it is necessary to switch pages frequently, and there is a problem that the data query operation is cumbersome. In this embodiment, through the above manner, the query function for the historical delivery data can be provided in the intelligent object page, so that the historical delivery data distributed in different pages can be queried in the first intelligent object page, that is to say, the historical delivery data distributed in different pages can be queried without switching the page, thereby simplifying the complexity of the data query operation and improving the data query efficiency.

In a possible implementation, in order to quickly answer the user's questions, such as questions about the data analysis result and/or the delivery recommendation for the content delivery policy, without switching the page, the first intelligent object page may also be used to provide a chat function, so that the intelligent object page can provide intelligent question answering capabilities in the whole process, so that the user can interact with the intelligent object through the chat function to solve problems encountered in any scenario in the first intelligent object page, thereby further improving the user experience.

In a possible implementation, in order to quickly display the historical query content, a query control “History” for viewing the historical query content may also be displayed in the first intelligent object page, as shown in FIG. 10. Therefore, when the user triggers the query control “History” by clicking or other operations, the historical content viewing panel may be displayed, and the historical query content may be displayed in the historical content viewing panel. Therefore, the user can quickly review the previous query content when needed, thereby further improving the user experience.

In a possible implementation, in order to avoid the historical query content affecting the context understanding of the current query content, a chat control “New chat” for starting a new chat may also be displayed in the first intelligent object page, as shown in FIG. 10. Therefore, when the user triggers the chat control “New chat” by clicking or other operations, a new chat with the intelligent object can be quickly started. Therefore, the context understanding in the new chat can be made not to be affected by the historical query content, thereby improving the accuracy of the reply content of the intelligent object.

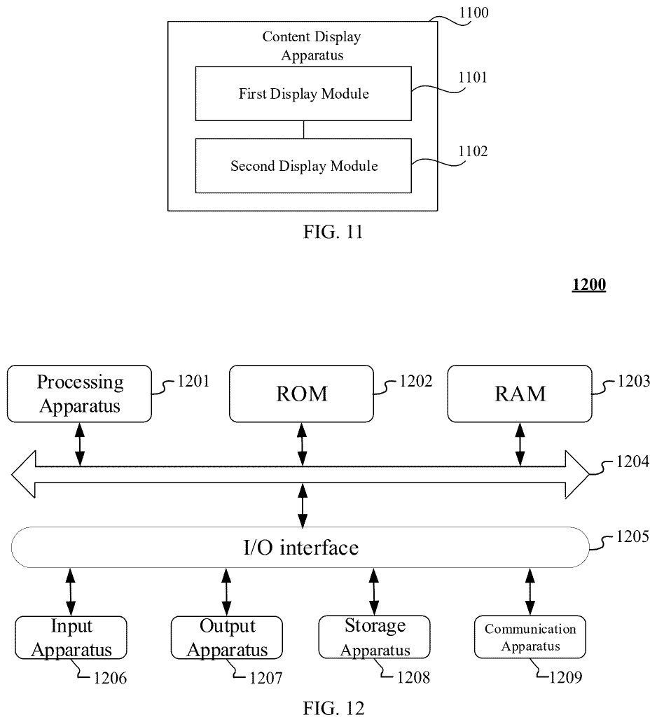

Based on the same concept, an embodiment of the present disclosure further provides a content display apparatus. As shown in FIG. 11, the content display apparatus 1100 may include:
a first display module 1101, used to display an identification of an intelligent object in a page of a content delivery platform, where the intelligent object is at least used to provide a data analysis result of historical delivery data and/or a delivery recommendation for a content delivery policy; and
a second display module 1102, used to display the data analysis result and/or the delivery recommendation through the intelligent object in response to interaction operation information in the page meeting a preset condition.

According to the above content display apparatus 1100, in response to the interaction operation information in the page meeting the preset condition, the data analysis result and/or the delivery recommendation can be automatically generated through the intelligent object, and the data analysis result and/or the delivery recommendation can reach the user through the intelligent object. Therefore, the data analysis result and/or the delivery recommendation can be automatically generated, the difficulty of generating the data analysis result and/or the delivery recommendation can be reduced, and the efficiency of generating the data analysis result and/or the delivery recommendation can be improved. In addition, since the data analysis result and/or the delivery recommendation can proactively reach the users through a new interaction form of the intelligent object, not only the display content of the page is enriched, but also the users can view the data analysis result and/or the delivery recommendation in time when the data analysis result and/or the delivery recommendation are displayed, thereby improving the rate of the users responding to the data analysis result and/or the delivery recommendation.

In a possible implementation, the second display module 1102 may include:
a first display unit, used to display preview information of the data analysis result and/or the delivery recommendation and a first control, where the first control is used to trigger the displaying of detailed information of the data analysis result and/or the delivery recommendation; and
a second display unit, used to display, in response to a trigger operation on the first control, a first intelligent object page associated with the intelligent object, and display the detailed information of the data analysis result and/or the delivery recommendation through the first intelligent object page.

In a possible implementation, the first display unit may be used to display a first number of delivery recommendations in the first preset display region, and correspondingly, the second display unit may include:
a first display subunit, used to display a second number of delivery recommendations in the first intelligent object page, where the second number of delivery recommendations include the first number of delivery recommendations, and second controls are displayed in association with each of the second number of delivery recommendations, and the second controls are at least used to trigger the displaying of detailed information of the associated delivery recommendation; and
a second display subunit, used to display, in response to a trigger operation on any target control in the second controls, detailed information of a target delivery recommendation associated with the target control.

In a possible implementation, the second display subunit may be used to display, in response to the trigger operation on any target control in the second controls, the detailed information of the target delivery recommendation associated with the target control in the first intelligent object page, and correspondingly, the second display module 1102 may further include:
a third display unit, used to display a third control for the target delivery recommendation in the first intelligent object page, where the third control is used for the user to modify a content delivery policy based on the target delivery recommendation.

In a possible implementation, the second display module 1102 may further include:
a fourth display unit, used to display a fourth control for the user to perform an adoption operation on the delivery recommendation in a second preset region; and
a fifth display unit, used to display, in response to a trigger operation on the fourth control, a second intelligent object page associated with the intelligent object, and display detailed information of the delivery recommendation and a fifth control in the second intelligent object page, where the fifth control is used for the user to modify a content delivery policy based on the delivery recommendation.

In a possible implementation, the second display module 1102 may further include:
a sixth display unit, used to display first prompt information associated with the first control in a third preset region, where the first prompt information is used to prompt virtual resource information associated with the first control; or, in response to the third control being displayed in the first intelligent object page, display second prompt information associated with the third control in the first intelligent object page, where the third control is used for the user to modify a content delivery policy based on the target delivery recommendation, and the second prompt information is used to prompt virtual resource information associated with the third control.

In a possible implementation, the intelligent object page is also used to provide a query function for the historical delivery data, and correspondingly, the second display module 1102 may further include:
a seventh display unit, used to display, in response to description information for querying the historical delivery data being input in the first intelligent object page, target delivery data obtained by the intelligent object based on the description information in the first intelligent object page.

In a possible implementation, the second display module 1102 may further include:
an eighth display unit, used to display, in response to the interaction operations in the page not including a content edit operation, the data analysis result and/or the delivery recommendation through the intelligent object; and/or, in response to the interaction operations in the page not including a recharge operation, display the data analysis result and/or the delivery recommendation through the intelligent object.

Based on the same concept, an embodiment of the present disclosure further provides a computer-readable medium having computer programs stored thereon, the computer programs, when executed by a processing apparatus, implement the steps of any one of the above content display methods.

Based on the same concept, an embodiment of the present disclosure further provides an electronic device, including:
a storage apparatus having computer programs stored thereon; and
a processing apparatus, used to execute the computer programs in the storage apparatus to implement the steps of any one of the above content display methods.

Based on the same concept, an embodiment of the present disclosure further provides a computer program product, including computer programs, and when the computer programs are executed by a processor, the steps of any one of the above content display methods are implemented.

Reference is made to FIG. 12 below, which illustrates a structural schematic diagram of an electronic device 1200 suitable for implementing the embodiments of the present disclosure. The terminal device in the embodiment of the present disclosure may include, but not limited to, mobile terminals such as a mobile phone, a notebook computer, a digital broadcast receiver, a personal digital assistant (PDA), a tablet computer, a portable multimedia player (PMP), a vehicle-mounted terminal (such as a vehicle-mounted navigation terminal), and fixed terminals such as a digital TV and a desktop computer. The electronic device shown in FIG. 12 is only an example, and should not bring any limitation to the function and use scope of the embodiments of the present disclosure.

As shown in FIG. 12, the electronic device 1200 may include a processing apparatus (such as a central processing unit, a graphics processor, etc.) 1201, which can execute various appropriate actions and processes according to a program stored in a read-only memory (ROM) 1202 or a program loaded from a storage apparatus 1208 into a random access memory (RAM) 1203. The RAM 1203 further stores various programs and data required for the operations of the electronic device 1200. The processing apparatus 1201, the ROM 1202, and the RAM 1203 are connected with each other through a bus 1204. An input/output (I/O) interface 1205 is also connected to the bus 1204.

Generally, the following apparatuses may be connected to the I/O interface 1205: an input apparatus 1206 including, for example, a touchscreen, a touchpad, a keyboard, a mouse, a camera, a microphone, an accelerometer, a gyroscope, etc.; an output apparatus 1207 including, for example, a liquid crystal display (LCD), a speaker, a vibrator, etc.; a storage apparatus 1208 including, for example, a magnetic tape, a hard disk, etc.; and a communication apparatus 1209. The communication apparatus 1209 may allow the electronic device 1200 to perform wireless or wired communication with other devices to exchange data. Although FIG. 12 shows the electronic device 1200 with various apparatuses, it should be understood that not all of the illustrated apparatuses are required to be implemented or provided. Alternatively, more or fewer apparatuses may be implemented or provided.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1209 and installed, or may be installed from the storage apparatus 1208, or may be installed from the ROM 1202. When the computer program is executed by the processing apparatus 1201, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: displaying an identification of an intelligent object in a page of a content delivery platform, the intelligent object is at least used to provide a data analysis result of historical delivery data and/or a delivery recommendation for a content delivery policy; and in response to interaction operation information in the page meeting a preset condition, displaying the data analysis result and/or the delivery recommendation through the intelligent object.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. Among them, the name of the module does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A content display method, comprising:
displaying an identification of an intelligent object in a page of a content delivery platform, wherein the intelligent object is at least used to provide a data analysis result of historical delivery data and/or a delivery recommendation for a content delivery policy; and
displaying, in response to interaction operations in the page meeting a preset condition, the data analysis result and/or the delivery recommendation through the intelligent object.

2. The content display method according to claim 1, wherein the displaying the data analysis result and/or the delivery recommendation through the intelligent object comprises:
displaying preview information of the data analysis result and/or the delivery recommendation and a first control, wherein the first control is used to trigger displaying of detailed information of the data analysis result and/or the delivery recommendation; and
displaying, in response to a trigger operation on the first control, a first intelligent object page associated with the intelligent object, and displaying the detailed information of the data analysis result and/or the delivery recommendation through the first intelligent object page.

3. The content display method according to claim 2, wherein the displaying the preview information of the delivery recommendation comprises:
displaying a first number of delivery recommendations in a first preset display region; and
the displaying the detailed information of the delivery recommendation through the first intelligent object page comprises:
displaying a second number of delivery recommendations in the first intelligent object page, wherein the second number of delivery recommendations comprise the first number of delivery recommendations, and second controls are displayed in association with each of the second number of delivery recommendations, and the second controls are at least used to trigger displaying of detailed information of the associated delivery recommendation; and
displaying, in response to a trigger operation on any target control in the second controls, detailed information of a target delivery recommendation associated with the target control.

4. The content display method according to claim 3, wherein the displaying, in response to the trigger operation on any target control in the second controls, the detailed information of the target delivery recommendation associated with the target control comprises:
displaying, in response to the trigger operation on any target control in the second controls, the detailed information of the target delivery recommendation associated with the target control in the first intelligent object page; and
the content display method further comprises:
displaying a third control for the target delivery recommendation in the first intelligent object page, wherein the third control is used for the user to modify a content delivery policy based on the target delivery recommendation.

5. The content display method according to claim 2, wherein the content display method further comprises:
displaying a fourth control for the user to perform an adoption operation on the delivery recommendation in a second preset region; and
displaying, in response to a trigger operation on the fourth control, a second intelligent object page associated with the intelligent object, and displaying detailed information of the delivery recommendation and a fifth control in the second intelligent object page, wherein the fifth control is used for the user to modify a content delivery policy based on the delivery recommendation.

6. The content display method according to claim 2, wherein the content display method further comprises:
displaying first prompt information associated with the first control in a third preset region, wherein the first prompt information is used to prompt virtual resource information associated with the first control; or,
displaying, in response to a third control being displayed in the first intelligent object page, second prompt information associated with the third control in the first intelligent object page, wherein the third control is used for the user to modify a content delivery policy based on the target delivery recommendation, and the second prompt information is used to prompt virtual resource information associated with the third control.

7. The content display method according to claim 2, wherein the first intelligent object page is further used to provide a query function for the historical delivery data, and the content display method further comprises:
displaying, in response to description information for querying the historical delivery data being input in the first intelligent object page, target delivery data obtained by the intelligent object based on the description information in the first intelligent object page.

8. The content display method according to claim 1, wherein the displaying, in response to the interaction operations in the page meeting the preset condition, the data analysis result and/or the delivery recommendation through the intelligent object comprises:
displaying, in response to the interaction operations in the page not comprising a content edit operation, the data analysis result and/or the delivery recommendation through the intelligent object; and/or,
displaying, in response to the interaction operations in the page not comprising a recharge operation, the data analysis result and/or the delivery recommendation through the intelligent object.

9. A non-transitory computer-readable medium having computer-executable instructions stored thereon, the computer-executable instructions, when executed by a processor, cause the processor to perform a content display method, the content display method comprising:
displaying an identification of an intelligent object in a page of a content delivery platform, wherein the intelligent object is at least used to provide a data analysis result of historical delivery data and/or a delivery recommendation for a content delivery policy; and
displaying, in response to interaction operations in the page meeting a preset condition, the data analysis result and/or the delivery recommendation through the intelligent object.

10. The non-transitory computer-readable medium according to claim 9, wherein the displaying the data analysis result and/or the delivery recommendation through the intelligent object comprises:
displaying preview information of the data analysis result and/or the delivery recommendation and a first control, wherein the first control is used to trigger displaying of detailed information of the data analysis result and/or the delivery recommendation; and
displaying, in response to a trigger operation on the first control, a first intelligent object page associated with the intelligent object, and displaying the detailed information of the data analysis result and/or the delivery recommendation through the first intelligent object page.

11. The non-transitory computer-readable medium according to claim 10, wherein the displaying the preview information of the delivery recommendation comprises:
displaying a first number of delivery recommendations in a first preset display region; and
the displaying the detailed information of the delivery recommendation through the first intelligent object page comprises:
displaying a second number of delivery recommendations in the first intelligent object page, wherein the second number of delivery recommendations comprise the first number of delivery recommendations, and second controls are displayed in association with each of the second number of delivery recommendations, and the second controls are at least used to trigger displaying of detailed information of the associated delivery recommendation; and
displaying, in response to a trigger operation on any target control in the second controls, detailed information of a target delivery recommendation associated with the target control.

12. The non-transitory computer-readable medium according to claim 11, wherein the displaying, in response to the trigger operation on any target control in the second controls, the detailed information of the target delivery recommendation associated with the target control comprises:
displaying, in response to the trigger operation on any target control in the second controls, the detailed information of the target delivery recommendation associated with the target control in the first intelligent object page; and
the content display method further comprises:
displaying a third control for the target delivery recommendation in the first intelligent object page, wherein the third control is used for the user to modify a content delivery policy based on the target delivery recommendation.

13. The non-transitory computer-readable medium according to claim 10, wherein the content display method further comprises:
displaying a fourth control for the user to perform an adoption operation on the delivery recommendation in a second preset region; and
displaying, in response to a trigger operation on the fourth control, a second intelligent object page associated with the intelligent object, and displaying detailed information of the delivery recommendation and a fifth control in the second intelligent object page, wherein the fifth control is used for the user to modify a content delivery policy based on the delivery recommendation.

14. The non-transitory computer-readable medium according to claim 10, wherein the content display method further comprises:
displaying first prompt information associated with the first control in a third preset region, wherein the first prompt information is used to prompt virtual resource information associated with the first control; or,
displaying, in response to a third control being displayed in the first intelligent object page, second prompt information associated with the third control in the first intelligent object page, wherein the third control is used for the user to modify a content delivery policy based on the target delivery recommendation, and the second prompt information is used to prompt virtual resource information associated with the third control.

15. The non-transitory computer-readable medium according to claim 10, wherein the first intelligent object page is further used to provide a query function for the historical delivery data, and the content display method further comprises:
displaying, in response to description information for querying the historical delivery data being input in the first intelligent object page, target delivery data obtained by the intelligent object based on the description information in the first intelligent object page.

16. The non-transitory computer-readable medium according to claim 9, wherein the displaying, in response to the interaction operations in the page meeting the preset condition, the data analysis result and/or the delivery recommendation through the intelligent object comprises:
displaying, in response to the interaction operations in the page not comprising a content edit operation, the data analysis result and/or the delivery recommendation through the intelligent object; and/or,
displaying, in response to the interaction operations in the page not comprising a recharge operation, the data analysis result and/or the delivery recommendation through the intelligent object.

17. An electronic device, comprising:
a storage apparatus having computer programs stored thereon; and
a processing apparatus,
wherein, the computer programs, when executed by the processing apparatus, cause the processing apparatus to perform a content display method, the content display method comprising:
displaying an identification of an intelligent object in a page of a content delivery platform, wherein the intelligent object is at least used to provide a data analysis result of historical delivery data and/or a delivery recommendation for a content delivery policy; and
displaying, in response to interaction operations in the page meeting a preset condition, the data analysis result and/or the delivery recommendation through the intelligent object.

18. The electronic device according to claim 17, wherein the displaying the data analysis result and/or the delivery recommendation through the intelligent object comprises:
displaying preview information of the data analysis result and/or the delivery recommendation and a first control, wherein the first control is used to trigger displaying of detailed information of the data analysis result and/or the delivery recommendation; and
displaying, in response to a trigger operation on the first control, a first intelligent object page associated with the intelligent object, and displaying the detailed information of the data analysis result and/or the delivery recommendation through the first intelligent object page.

19. The electronic device according to claim 18, wherein the displaying the preview information of the delivery recommendation comprises:
displaying a first number of delivery recommendations in a first preset display region; and
the displaying the detailed information of the delivery recommendation through the first intelligent object page comprises:
displaying a second number of delivery recommendations in the first intelligent object page, wherein the second number of delivery recommendations comprise the first number of delivery recommendations, and second controls are displayed in association with each of the second number of delivery recommendations, and the second controls are at least used to trigger displaying of detailed information of the associated delivery recommendation; and
displaying, in response to a trigger operation on any target control in the second controls, detailed information of a target delivery recommendation associated with the target control.

20. The electronic device according to claim 19, wherein the displaying, in response to the trigger operation on any target control in the second controls, the detailed information of the target delivery recommendation associated with the target control comprises:
displaying, in response to the trigger operation on any target control in the second controls, the detailed information of the target delivery recommendation associated with the target control in the first intelligent object page; and
the content display method further comprises:
displaying a third control for the target delivery recommendation in the first intelligent object page, wherein the third control is used for the user to modify a content delivery policy based on the target delivery recommendation.
